(19) United States
(12) Patent Application Publication
(10) Pub. No.: US 2019/0212587 A1
(43) Pub. Date: Jul. 11, 2019

(54) ATHERMAL POCKELS CELL

(71) Applicant: THALES, Courbevoie (FR)

(72) Inventors: Eric DURAND, Guyancourt (FR); Christophe DERYCKE, Guyancourt (FR); Laurent BOUDJEMAA, Guyancourt (FR); Stephane DAVID, Guyancourt (FR)

(21) Appl. No.: 16/330,044

(22) PCT Filed: Sep. 14, 2017
(86) PCT No.: PCT/EP2017/073105

§ 371 Date: Mar. 1, 2019

(30) Foreign Application Priority Data
Sep. 22, 2016 (FR) 16/01378

(51) Int. Cl. G02F 1/03; H01S 3/107; G02F 1/01

(52) U.S. Cl. CPC G02F 1/0322; G02F 2203/60; G02F 1/0136; H01S 3/107

(57) ABSTRACT

A Pockels cell that includes two similar electro-optical crystals oriented to achieve temperature compensation on a horizontal metal base common to the two crystals, and a carrier structure. It includes, between the base and the carrier structure, a thermally conductive element, which has a configuration that is symmetric about a vertical plane passing between the two crystals, in order to symmetrically distribute, to the base, a heat flux generated in the carrier structure asymmetrically with respect to the vertical plane.

The field of the invention is that of Pockels cells, which are in particular used in the fields of the amplification of laser beams and of wavelength switches.

Electro-optical materials change the polarization of light via the application of an electrical voltage to the interior of the material. These materials are often associated with polarizers, so as to produce electro-optical switches, which are also referred to as Pockels cells. A polarizer lets pass selectively a light beam the polarization of which is in a preset state. An electro-optical material allows this state to be changed via the application of a voltage. It is thus possible to control the transmission of the light beam by way of an electrical voltage.

Pockels cells have been used in many configurations in the field of amplification of laser beams. One of these configurations, which is also referred to as “Q-switching”, consists in activating a Pockets cell located in the laser cavity, so as to increase the losses of an oscillator (or equivalently to decrease the transmittance of the cell): the laser pulse is then trapped in the cavity. By suddenly applying a voltage to the Pockels cell, the losses of the cavity are removed, thereby allowing the laser pulse to be freed. Q-switched laser oscillators (which generate short pulses, typically of duration comprised between 5 ns and 40 ns) are based on this effect.

Pockels cells containing two transverse-field crystals mounted to achieve temperature compensation allow optical switches that switch with low electrical voltages to be produced. These cells employ two electro-optical crystals in series, thereby allowing the level of the voltage to be applied to activate them to be decreased. The crystals used are in general what are called biaxial crystals: their natural birefringence depends on their cutting axis (X or Y axes) and also varies greatly with temperature. Mounting the crystals to achieve temperature compensation, by precisely orientating them with respect to each other, allows the natural birefringence of one crystal to be compensated for by that of the other. This compensation is effective over an extremely wide temperature range, for example from −40° to +60°. The quality of the compensation, which is the origin of the temperature range over which the Pockels cell will be operational, depends on the relative precision with which the two crystals are positioned, but also on their similarity. Matched pairs of crystals are spoken of. As their name indicates, such matched pairs of crystals must be as similar as possible. For this reason, the two crystals of these cells are generally polished together so as to ensure their dimensions are identical.

Suitably choosing and mounting crystals (which are as similar as possible) ensures the Pockels cell will operate correctly over very wide temperature ranges, provided that the temperature compensation achieved via the crystals is not lost.

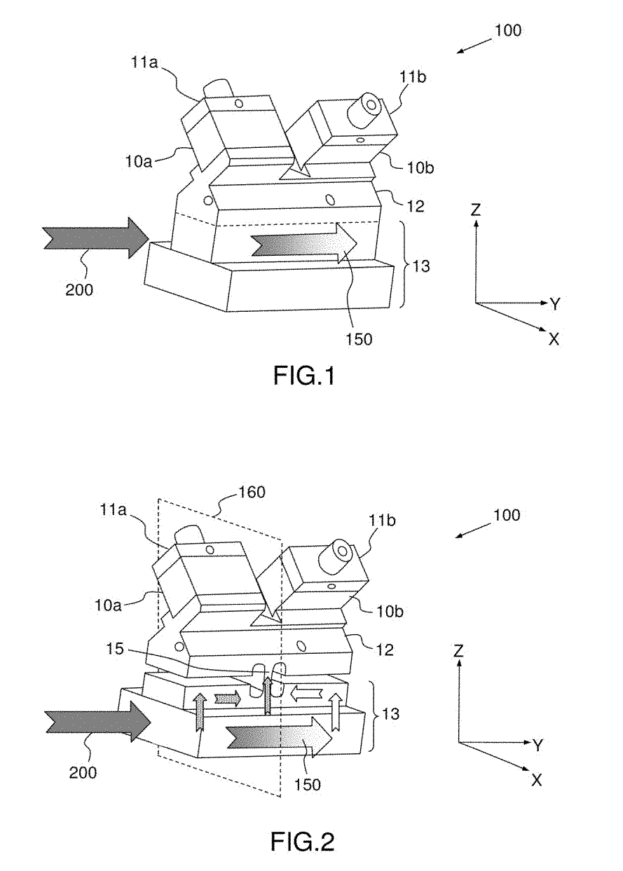

FIG. 1 shows a Pockels cell 100 containing two crystals 10a, 10b that are mounted to achieve temperature compensation, according to the prior art. The matched pair of two crystals are positioned on and adhesively bonded to a common base 12 that also serves as an electrode. A metal plate 11a, 11b adhesively bonded to each crystal 10a, 10b allows the voltage to be applied and the transmittance of the cell to be modified. The base 12 is fastened to a carrier structure 13.

However, such a Pockels cell is often adversely affected by exterior factors inherent to the targeted applications. Laser amplifiers or oscillators require a gain medium to be pumped: it is necessary to supply to the gain medium light energy so as to store it in order to subsequently deliver it in the form of a coherent monochromatic beam. This is the laser effect.

This supply of light energy to the gain medium is not perfect, because some of the energy required to produce it is transformed into heat 200.

It was seen above that Pockels cells containing two crystals mounted to achieve compensation operate correctly over wide temperature ranges provided that the crystals preserve their similarity so as to maintain the temperature compensation. However, if the thermal power generated by the pumping induces a temperature difference between the two crystals, such as illustrated in FIG. 1 by the arrow 150 (indicating decreasing magnitude), then a disparity is created and the cell 100 no longer operates correctly.

Removal of the thermal power thus generated is generally not a problem in a “terrestrial” environment subject to few constraints: transfer of the generated thermal power to the cell is prevented by either moving it further away, or by thermally insulating it from the heat source as described for example in patent EP 1 532 482. The first solution is not desirable in a space environment as the equipment must occupy a minimum volume. The second solution is also difficult to implement effectively in a small bulk without weakening the rigidity of the equipment.

In an environment subject to more constraints, such as a space environment for example, and in which bulk is very limited and the use of coolants is proscribed, the thermal power generated by the pumping is most often removed by conduction through the structures bearing the equipment. In this constraining environment, the Pockels cell is most often located in the immediate vicinity of the heat source. The thermal power generated by the pumping system is then inevitably transferred to the Pockels cell.

Therefore, there remains to this day a need for a Pockels cell that simultaneously satisfies all the aforementioned requirements, in terms of heat removal, and the requirements of constraining environments, such as the space environment, in which bulk is very limited and the use of coolants is proscribed.

Rather than prevent the transmission of the thermal power to the Pockels cell in order to avoid the creation of a temperature gradient between the two crystals, the Pockels cell according to the invention includes means that ensure this power is transferred to the two crystals of the cell symmetrically, in order to prevent the compensation achieved via the crystals from being lost.

More precisely, one subject of the invention is a Pockels cell that includes:

two similar electro-optical crystals oriented to achieve temperature compensation on

a horizontal metal base common to the two crystals, and

a carrier structure.

It is mainly characterized in that it includes, between the base and the carrier structure, a thermally conductive element, which has a configuration that is symmetric about a vertical plane passing between the two crystals, in order to symmetrically distribute, to the base, a heat flux generated in the carrier structure asymmetrically about this vertical plane.

Thus, when a thermal source located nearby generates thermal power that is dissipated in the carrier structure of the equipment asymmetrically, the heat flux can be transferred to the crystals only by way of the thermally conductive element. By virtue of this element, which is located in a plane of symmetry of the cell right in the middle of the two crystals, the heat flux, which is asymmetric in the carrier structure, is distributed symmetrically in each of the two crystals of the Pockels cell: this prevents a temperature gradient from forming between the crystals. The compensation is therefore preserved whatever the heat flux dissipated in the cell. This solution is compact (requires no increase in volume) and is independent of the heat flux to be dissipated.

This thermally conductive element is for example a vertical strip.

It may also consist:
of a horizontal frame intended to make contact with the carrier structure, with its centre apertured;
a horizontal plate on which the base is mounted, this plate being connected to the frame by
an arm located in the vertical plane passing midway between the two crystals.

According to another embodiment, the thermally conductive element is a horizontal platen equipped with heat pipes that are placed on the edges of the platen and perpendicular to the vertical plane passing midway between the two crystals.

Another subject of the invention is a Q-switched laser comprising a laser cavity including a Pockels cell such as described, or a wavelength switch that includes a laser and, immediately after the exit of the laser, a Pockels cell such as described, then a device allowing the wavelength to be changed.

Other features and advantages of the invention will become apparent on reading the following detailed description, which is given by way of nonlimiting example and with reference to the appended drawings, in which:

FIG. 1, which has already been described, schematically shows a Pockets cell according to the prior art, adversely affected by an external heat source;

FIG. 2 schematically shows an athermal Pockels cell according to the invention, subjected to an external heat source;

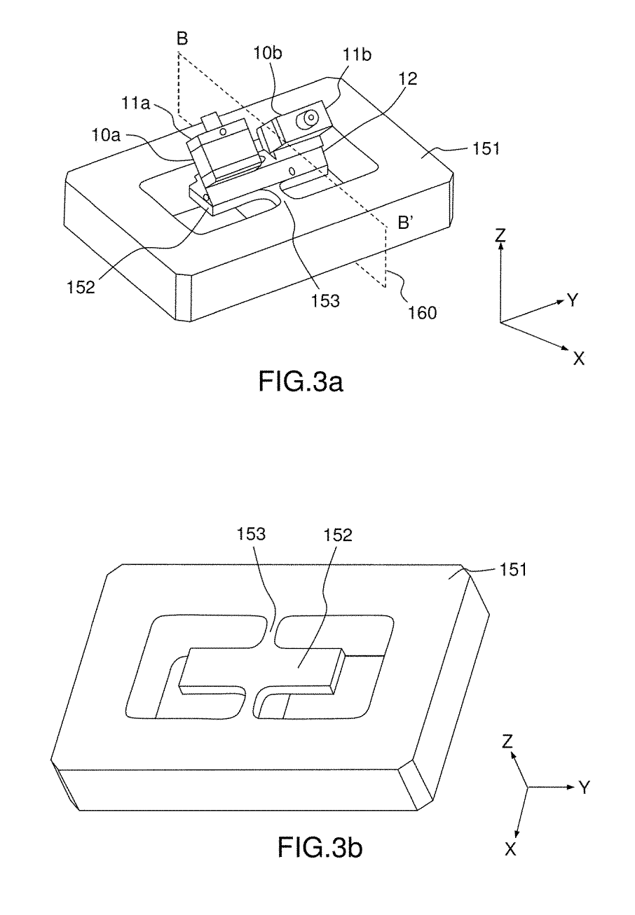

FIGS. 3a and 3b schematically show an example of a thermally conductive element of an athermal Pockels cell according to the invention, FIG. 3a showing a perspective view thereof and FIG. 3b showing a perspective view of the thermally conductive element alone;

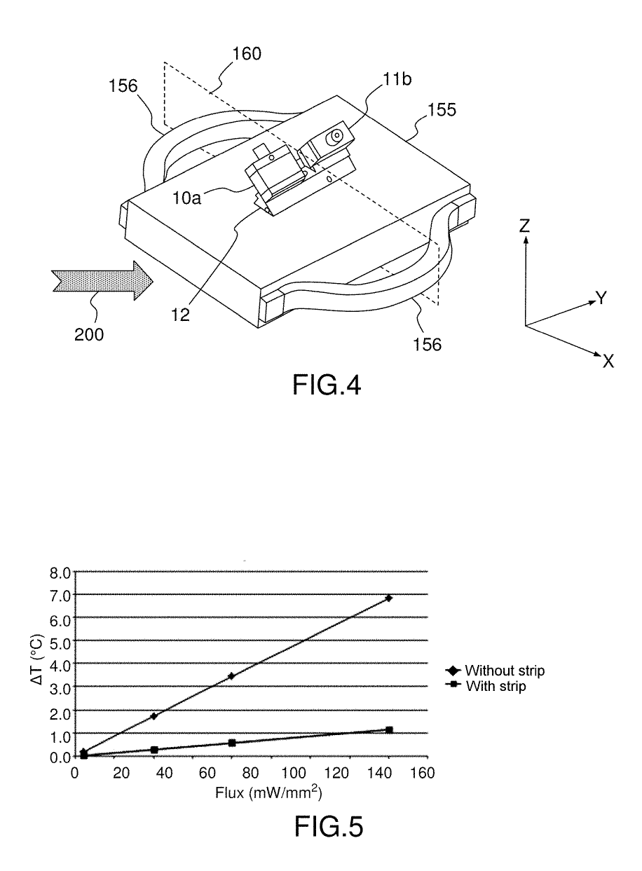

FIG. 4 schematically shows another example of a thermally conductive element of an athermal Pockels cell according to the invention, via a perspective view of the entire cell;

FIG. 5 illustrates the influence of the heat flux density (x-axis) on the difference in T° between the cells (on the y-axis), with and without conductive element.

In all the figures, elements that are the same have been referenced with the same references.

In the rest of the description, the terms “top”, “bottom”, “front”, “back”, “side”, “horizontal” and “vertical” are used with reference to the orientation of the described figures. In so far as the cell or the thermally conductive elements may be positioned with other orientations, the directional terminology is indicated by way of illustration and is nonlimiting.

Rather than prevent the transmission of the thermal power to the Pockets cell in order to avoid the creation of a temperature gradient, the invention acts so that this power is transferred to the two crystals of the cell symmetrically, in order to prevent the temperature compensation achieved via the crystals from being lost.

The Pockets cell according to the invention described with reference to FIGS. 2, 3a, 3b and 4 includes two similar parallelepipedal electro-optical crystals 10a, 10b oriented to achieve temperature compensation in the direction Y of the irradiation on a horizontal metal base 12 common to the two crystals. They are arranged one after the other on this base at a distance from each other. Each is equipped with electrodes on two surfaces that are opposite each other. The common base 12 also serves as a common electrode for the two crystals. A metal plate 11a, 11b adhesively bonded to each crystal 10a, 10b forms the second electrode and allows the voltage to be applied and the transmittance of the cell to be modified. The surface of the other electrode 11a of a crystal 10a is pivoted by 90° with respect to the surface of the other electrode 11b of the other crystal 10b about the direction Y of irradiation. The base 12 is fastened to a carrier structure 13.

An external thermal source 200 located nearby the carrier structure 13 generates thermal power that dissipates in the carrier structure of the cell asymmetrically with respect to the vertical plane 160. This thermal source may also make contact with the carrier structure.

Below, the thermal source 200 is considered to be a heat source generating a heat flux 150 that is asymmetric in the carrier structure, as shown in the example of FIG. 2, but the description applies in the same way to a cold source generating a cold flux.

According to the invention, the heat flux 150 present in the carrier structure 13 is transferred to the crystals 10a, 10b only by way of a thermally conductive element located between the base 12 and the carrier structure 13, and in contact therewith. This element has a configuration that is symmetric with respect to the vertical plane (in XZ therefore) 160 of symmetry passing between the two crystals 10a, 10b and midway therebetween. The asymmetric heat flux is therefore distributed symmetrically to the base 12 and therefore in each of the two crystals 10a, 10b, thereby preventing a temperature gradient from forming between the crystals. It thus allows the temperature gradient present in the carrier structure to be made symmetrical between the two crystals, in order to preserve the temperature compensation. The compensation is therefore preserved whatever the heat flux dissipated in the cell.

This solution is compact (no increase in volume is required) and is independent of the heat flux to be dissipated.

FIG. 2 shows a preferred embodiment employing a thermally conductive element taking the form of a strip 15 located in the vertical plane 160 of symmetry between the two crystals, and extending a length equal to the width (along X) of the base. It is thin along Y in order to better channel the conduction while preserving its solidity. According to this embodiment, the base 12 and the carrier structure 13 are separated by a gap filled with air (inter alia), except level with the strip.

The vertical strip 15 and the base 12 may form a single part. The vertical strip 15 and the carrier structure 13 may form a single part. Lastly, the vertical strip 15, the base 12 and the carrier structure 13 may form a single part as shown in FIG. 2. Portions of the base and of the carrier structure have been removed symmetrically with respect to the plane 160 level with the strip in order to promote the conduction of heat via the strip and to decrease conduction via the air-filled gap between the base and the carrier structure.

This solution is advantageous given the envisaged (space) environments, because it may be easily miniaturized.

Thermal simulations have allowed the thermal gradient induced in a standard Pockels cell such as shown in FIG. 1 to be compared to that calculated, under the same conditions, for an athermal Pockels cell such as shown in FIG. 2. These calculations, which are presented in FIG. 5, simulate the thermal behaviour of a Pockets cell in a typical case of exchange (heat flux of 80 mW/mm² over an area of 75 mm²). Natural convection, radiation and conduction are taken into account in these simulations. It will be noted that the temperature gradient between the crystals of the Pockels cell is 3.5° C. in a case representative of the prior art and 0.6° C. in an athermal configuration according to the invention. The difference increases as the external heat flux in question increases. Under the typical conditions considered here, the temperature gradient in the athermal Pockels cell is divided by almost 6 with respect to a prior-art Pockels cell.

A second example of an athermal Pockels cell according to the invention may be produced, which allows the thermal power of the external heat source to be channelled to the vertical plane of symmetry of the Pockels cell horizontally. The thermally conductive element shown in FIGS. 3a and 3b consists of a frame 151 that is horizontal (in XY) and preferably apertured, of preset vertical thickness (along Z) and intended to make contact with the carrier structure (which is not shown in FIGS. 3a and 3b). In its apertured centre there is placed a horizontal plate 152 that is preferably unapertured for thermal reasons, said plate being of vertical thickness smaller than the vertical thickness of the frame 151, the base 12 being mounted on said plate. Said plate is joined to the frame 151 by a (or two) apertured or unapertured arm(s) 153 that is located in the vertical plane 160 passing midway between the two crystals. The vertical thickness (along Z) of the arm 153 is for example equal to that of the frame 151 but may be smaller; as in the example of the strip 15 of FIG. 2, its width (along Y) is very much smaller than that of the plate 152 in order to concentrate the conduction through its channel. Other configurations are envisageable. For example, the dimension of the arm 153 along Z is such that the plate is raised with respect to the frame 151.

A third example of an athermal cell according to the invention may be produced, in which example the thermally conductive element shown in FIG. 4 is a horizontal platen 155 equipped with heat pipes 156 that are placed on the edges of the platen, perpendicular to the vertical plane 160 passing midway between the two crystals, in order to make symmetrical the dissipation of heat in the cell. This platen 155 may be rectangular as shown in the example of the figure but is not necessarily; more generally it has a shape that is symmetrical with respect to the vertical plane 160 passing between the crystals. It is intended to make contact with the carrier structure (not shown in FIG. 4).

Up to now in the description the carrier structure has been considered to have been subjected to a thermal source acting only from a “lateral” direction as illustrated in FIGS. 2 and 4, but of course it may also act from a plurality of lateral directions and/or from beneath the carrier structure 13.

The targeted applications are the production of Q-switched laser oscillators (switched with a Pockels cell). A similar application is the use of the Pockets cell to make an already existing light pulse enter into or exit from a laser amplifier. As for Q-switching, the ability to modify the polarization of the laser beam by applying a voltage is used. For these two applications, the Pockels cell is associated with a polarizer allowing the transmission of the laser beam to be controlled.

The Pockels cell may also be associated with any other element sensitive to the polarization of the laser light. For example, if instead of associating the cell with a polarizer, it is associated with a harmonic generator (allowing new wavelengths or new beam colours to be generated on the basis of a change in polarization), it is possible to create a wavelength switch, rather than a transmission-modifying device.

1. A Pockels cell that includes two similar electro-optical crystals oriented to achieve temperature compensation on a horizontal metal base common to the two crystals, and a carrier structure, wherein it includes, between the base and the carrier structure, a thermally conductive element, which has a configuration that is symmetric about a vertical plane passing between the two crystals, in order to symmetrically distribute, to the base, a heat flux generated in the carrier structure asymmetrically with respect to the vertical plane.

2. The Pockels cell according to claim 1, wherein the thermally conductive element is a vertical strip.

3. The Pockels cell according to claim 2, wherein the vertical strip and the base form a single part.

4. The Pockels cell according to claim 2, wherein the vertical strip and the carrier structure form a single part.

5. The Pockels cell according to claim 2, wherein the vertical strip, the base and the carrier structure form a single part.

6. The Pockels cell according to claim 1, wherein the thermally conductive element consists:
of a horizontal frame intended to make contact with the carrier structure, with its centre apertured;
a horizontal plate on which the base is mounted, and which is joined to the frame by
an arm that is located in the vertical plane passing between the two crystals.

7. The Pockels cell according to claim 1, wherein the thermally conductive element is a horizontal platen equipped with heat pipes that are placed on the edges of the platen perpendicular to the vertical plane passing between the two crystals.

8. A Q-switched laser comprising a laser cavity including a Pockels cell according to claim 1.

9. A wavelength switch that includes a laser and immediately after the exit of the laser, a Pockels cell according to claim 1.
